(19) United States
(12) Patent Application Publication
(10) Pub. No.: US 2005/0073942 A1
(43) Pub. Date: Apr. 7, 2005

(54) Optical recording medium and method of manufacturing the same

(75) Inventors: Atsushi Kondo, Koufu-shi (JP); Toshihiko Takishita, Koufu-shi (JP); Seiro Oshima, Koufu-shi (JP); Kazuo Kuroda, Tokorozawa-shi (JP); Toshio Suzuki, Tokorozawa-shi (JP); Eiji Muramatsu, Tokorozawa-shi (JP); Masahiro Kato, Tokorozawa-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/949,399

(22) Filed: Sep. 27, 2004

(30) Foreign Application Priority Data
Oct. 3, 2003 (JP) P2003-345785

(51) Int. Cl. G11B 7/24

(52) U.S. Cl. 369/286; 369/275.4

(57) ABSTRACT

An optical recording medium, in which a first substrate, a first recording layer, a first reflecting layer, an intermediate layer, a second recording layer, a second reflecting layer, and a second substrate are at least laminated, the optical recording medium further including a transcription layer between the second recording layer and the second reflecting layer. The optical recording medium of the invention can solve a problem of insufficient signal amplitude of one recording layer as compared with the other recording layer in a writable optical recording medium of a conventional double layer structure.

### BACKGROUND OF THE INVENTION

1. Field of the Invention

The present invention relates to an optical recording medium and a method of manufacturing the same. More particularly, the present invention relates to a writable optical recording medium of a double layer structure and a method of manufacturing the same.

2. Description of the Related Art

Optical recording mediums such as a DVD (digital versatile disc) are conventionally known as recording mediums for recording and reproducing various kinds of information. The known optical recording mediums include an optical recording medium of single layer type which has a layer for recording information from one side, and an optical recording medium of dual layer type which has two layers for recording information from one side.

Of these optical recording mediums, the optical recording medium of dual layer type has two layers for recording information (hereinafter simply referred to as recording layers), so that a large amount of information can be recorded and reproduced with high density. Further, since the optical recording medium of dual layer type makes it possible to record information on two recording layers from one side, it is not necessary to provide and switch optical pickups on the respective sides of the optical recording medium in a recording/reproducing apparatus for the optical recording medium. Moreover, the optical recording medium of dual layer type does not have to flip the optical recording medium during recording and reproduction. Thus, the optical recording medium of dual layer type enables so-called seamless recording and seamless reproduction.

As described above, the optical recording medium of dual layer type is advantageous in that it has superior functionarity for recording information, a recording/reproducing apparatus can have a simple configuration, and seamless recording and reproduction do not interrupt with the user who watches videos.

Regarding such DVDs, so-called DVD-R and DVD-RAM have been already developed which enable the user to record information.

Of these DVDs, a DVD-R has a basic configuration in which a pregroove of a spiral groove serving as the tracking device of an optical pickup is formed in an information recording region on a surface of a disc, on which a recording medium made of a material such as an organic dye is applied by spin coating and so on, and dried to form a recording layer, and a reflecting layer composed of a metal film is formed thereon.

For example, as shown in FIG. 1, Japanese Patent Laid-Open No. 11-66622 discloses an optical recording medium 10 as a DVD-R optical recording medium of dual layer type. In the optical recording medium 10, a first disc and a second disc are bonded to each other using an adhesive 4B and so on with a first reflecting layer 31B and a second recording layer 22B facing each other. The first disc is composed of a first substrate 11B, a first recording layer 21B made of an organic dye, and the semi-translucent first reflecting layer 31B, and the second disc is composed of a second substrate 12B, a second reflecting layer 32B, and a second recording layer 22B. In the optical recording medium 10, a laser beam is applied from the side of the first substrate 11B to record information in the recording layers 21B and 22B.

As is evident from FIG. 1, in the dual-layer type optical recording medium having both sides bonded to each other, a first groove G1B is formed on the first substrate 11B, and the first recording layer 21B and the first reflecting layer 31B are laminated in this order on a surface of the first substrate 11B, the first groove G1B being formed on the surface thereof. Meanwhile, a second groove G2B is formed on the second substrate 12B, and the second reflecting layer 32B and the second recording layer 22B are laminated in this order on a surface of the second substrate 12B, the second groove G2B being formed on the surface thereof. Therefore, a contact area between the second recording layer 22B and the second reflecting layer 32B is larger than a contact area between the first recording layer 21B and the first reflecting layer 31B.

In this case, when a laser beam is applied from the side of the first substrate 11B of the optical recording medium 10 to record information in the first recording layer 21B in the first groove G1B and the second recording layer 22B in the second groove G2B, a thermal behavior different between the first recording layer 21B in the first groove G1B and the second recording layer 22B in the second groove G2B. Thus, recording cannot be performed on the recording layers under the same conditions. To be specific, the second recording layer 22B in the second groove G2B is less prone to thermal deformation caused by a laser beam. Thus, when information is recorded in each groove by using a laser beam of a constant energy, the second groove G2B may not obtain a sufficient signal amplitude.

Comparing the hardness of the first substrate 11B making contact with the first groove G1B and the hardness of the second reflecting layer 32B making contact with the second groove G2B, the second reflecting layer 32B is harder in ordinary cases. Hence, a laser beam is less likely to cause thermal deformation around a boundary surface of the second reflecting layer 32B. Consequently, as in the foregoing case, the second groove G2B may not obtain a sufficient signal amplitude as compared with the first groove G1B.

The present invention is devised in view of the circumstances. An example of an object of the present invention is to provide an optical recording medium which can solve the problem of the conventional writable optical recording medium of a double layer structure, in which one recording layer cannot obtain a sufficient signal amplitude as compared with the other. Another example of the object of the present invention is to provide a method for readily manufacturing the optical recording medium.

### SUMMARY OF THE INVENTION

A mean for solving the problem according to claim 1 is an optical recording medium, in which a first substrate having a first groove formed thereon, a first recording layer formed on a first-groove forming surface of the first substrate, a semi-translucent first reflecting layer, an intermediate layer, a second recording layer, a second reflecting layer, and a second substrate are at least disposed in this order from the side where a laser beam for recording, reproduction, or recording/reproduction is applied, the optical recording medium further comprising a translucent transcription layer, which has a second groove formed thereon, between the second recording layer and the second reflecting layer.

A mean for solving the problem according to claim 3 is a method of manufacturing an optical recording medium, the method comprising the steps of: laminating a first recording layer made of a dye material and a semi-translucent first reflecting layer in this order on a first-groove forming surface of a first substrate, laminating a second reflecting layer, a transcription layer having a second groove formed thereon, and a second recording layer made of a dye material in this order on one side of a second substrate, and bonding the first and second substrates on which several layers are provided, respectively, to each other via an intermediate layer with the first reflecting layer and the second recording layer facing each other.

### BRIEF DESCRIPTION OF THE DRAWINGS

FIG. 1 is a sectional view showing an optical recording medium of the conventional art;

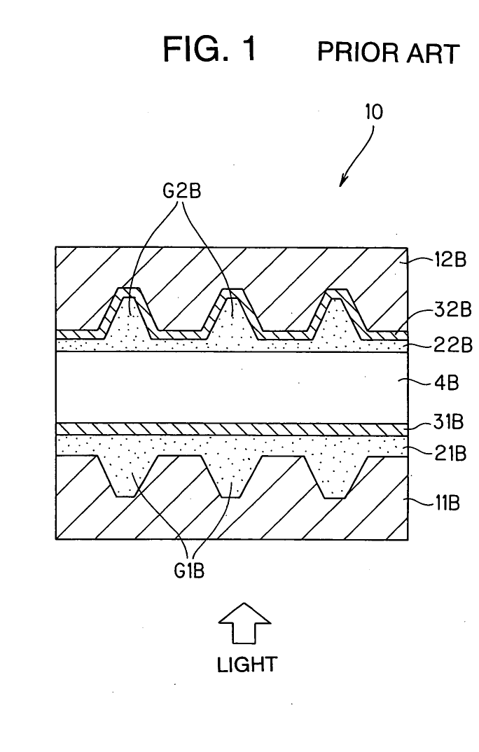

FIG. 2 is a sectional view showing an optical recording medium according to an embodiment of the present invention; and

FIG. 3 is a sectional view showing an optical recording medium according to another embodiment of the present invention.

### DETAILED DESCRIPTION OF THE PREFERRED EMBODIMENTS

An optical recording medium of the present invention will be specifically described below in accordance with the accompanying drawings.

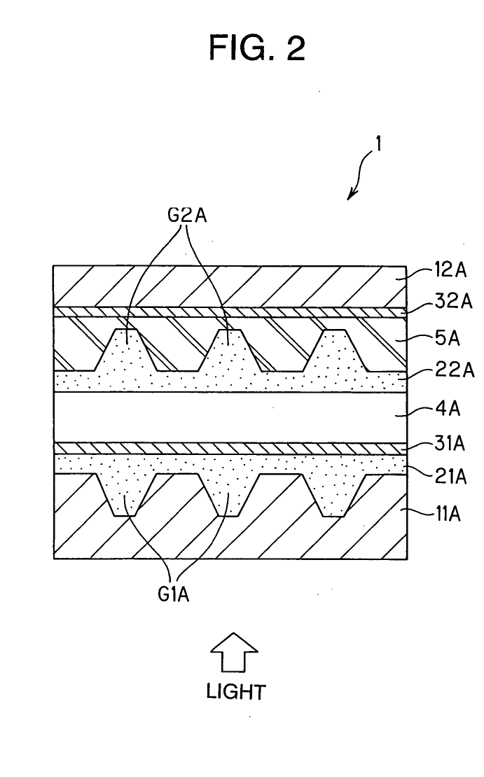

FIG. 2 is a sectional view which partially shows the optical recording medium along the thickness direction according to an embodiment of the present invention. In FIG. 2, the thicknesses of layers are larger than actual thicknesses.

First, the configuration of the optical recording medium will be discussed below according to the present embodiment.

As shown in FIG. 2, in an optical recording medium 1 of the present embodiment, a first substrate 11A having a first groove G1A formed thereon, a first recording layer 21A formed on said first groove G1A on a surface of the first substrate 11A, a first reflecting layer 31A, an intermediate layer 4A, a second recording layer 22A, a transcription layer 5A having a second groove G2A thereon, a second reflecting layer 32A, and a second substrate 12A are disposed in this order from the side where a laser beam for recording, reproduction, or recording/reproduction is applied.

That is, the optical recording medium 1 of the present invention is similar to the conventional optical recording medium in that the first recording layer 21A is formed on the surface of the first substrate 11A, the surface having the first groove G1A formed thereon. However, the transcription layer 5A having the second groove G2A formed thereon is provided between the second recording layer 22A and the second reflecting layer 32A and thus the second substrate 12A has no groove and only the second reflecting layer 32A is formed on the second substrate 12A. The second groove G2A is formed on the transcription layer 5A which is provided on the second reflecting layer 32A. In this case, in the optical recording medium 1 according to the present invention, the first recording layer 21A in the first groove G1A is surrounded by the first substrate 11A and the second recording layer 22A in the second groove G2A is surrounded by the transcription layer 5A. Consequently, even when a laser beam is applied from the side of the first substrate 11A to record information in the recording layers in the grooves G1A and G2A, the second groove G2A and the second reflecting layer 32A are not in direct contact with each other and thus thermal behavior of the first groove G1A and the second groove G2A can be similar to each other by taking the material of the transfer layer 5A into consideration. Consequently, thermal deformation similar to that of the first groove G1A can be sufficiently made by a laser beam also on the second groove G2A, thereby achieving equal signal amplitude in each of the recording layers. Moreover, according to the optical recording medium 1 of the present invention, by considering the material of the transcription layer 5A, the first substrate 11A having the first groove G1A formed thereon and the transfer layer 5A having the second groove G2A formed thereon can be almost equal in hardness. Consequently, thermal deformation similar to that of the first groove G1A occurs even around the boundary surface of the second grooves G2A with the transcription layer 5A, thereby preventing the reduction of signal amplitude in the first groove G1A. That is to say, the transcription layer 5A in the optical recording medium 1 of the present invention is provided in order to achieve such object that a hardness of each layer where the first and the second grooves are formed can be substantially the same and thermal deformation caused by radiation of a laser beam to said layers may occur substantially to the same extent. Incidentally, the term “transcription” in the present application is used metaphorically in a sense that such construction in a combination of the transcription layer 5A, the second grooves G2A and the second recording layer 22A is considered as if it would be a transcription of a combination of the first substrate 11A, the first grooves G1A and the first recording layer 21A. It does not mean any actual transcription of something.

The transcription layer 5A in the optical recording medium 1 of the present invention can be made of any material in consideration of the role of the transcription layer 5A, so long as the material has substantially the same thermal behavior as the first substrate 11A and is substantially equal in hardness to the first substrate 11A. From the practical point of view, it is preferable to form the transcription layer 5A by using the same material in the first substrate 11A. The thickness of the transcription layer 5A is normally 10 to 180 nm.

The material of the first substrate 11A is a highly transparent resin, e.g., a resin having a light transmittance of 80% or higher for a laser beam for recording, reproduction, or recording/reproduction. A resin with a light transmittance of 90% or higher is more preferable. To be specific, for example, a polycarbonate resin, an acrylic resin such as polymethyl methacrylate, and a polyolefin resin are available. The material of the first substrate 11A is not limited to these resins.

The thickness of the first substrate 11A is normally 0.1 to 0.6 mm, which is determined according to the specification of the optical recording medium 1. That is, when the optical recording medium 1 is a DVD-R disc for a red laser, the first substrate 11A is 0.6 mm in thickness. When the optical recording medium 1 is a disc for a blue laser, the first substrate 11A is 0.1 mm or 0.6 mm in thickness. Besides, the first substrate 11A is a circular plate having a hole at the center.

The first groove G1A is formed on a surface of the first substrate 11A, the surface having the first recording layer 21A formed thereon. The groove is normally about 100 to 180 nm in depth, about 0.25 to 0.35 μm in width, and about 0.7 to 0.9 μm in pitch.

The groove is shaped like a spiral or concentric circles, taken from the surface of the first substrate 11A. Further, the groove may meander in the radius direction at predetermined intervals. Hereinafter, such a meandering groove is referred to as a wobble groove. Furthermore, prepits carrying address information and so on may be formed at predetermined intervals on lands positioned between the grooves.

The material of the first recording layer 21A capable of optical recording is not particularly limited as long as the material is an organic dye used for the recording layer of the conventional optical recording medium. For example, a complex of an azo compound, cyanine dye, phthalocyanine dye, and so on are used. The first recording layer 21A normally has a thickness of 50 to 120 nm, which is not particularly limited.

The first reflecting layer 31A is made of metals including gold, aluminum, silver, copper and an alloy of these metals. The material of the first reflecting layer 31A is not limited to these metals. The first reflecting layer 31A normally has a thickness of about 10 to 20 nm, which is not particularly limited as long as semi-translucency is obtained, that is, a light beam for recording, reproduction, or recording/reproduction can be passed or reflected at a wavelength of the light.

The second substrate 12A is similar to the first substrate 11A in material, thickness, and shape.

The material of second reflecting layer 32A is the same as the first reflecting layer 31A described above. However, unlike the first reflecting layer 31A, the material of the second reflecting layer 32A does not have to be semi-translucent. Further, the thickness of the second reflecting layer 32A is properly selected within a range of the total reflection of a laser beam for recording/reproduction. For example, a thickness of 50 nm or larger is selected. Moreover, in the optical recording medium 1 of the present invention, the second reflecting layer 32A can have a flat surface in parallel with a surface of the second substrate 12A. As described above, this is because a groove for forming the second groove is not formed on the second substrate 12A in the optical recording medium 1 of the present invention.

As described above, the transcription layer 5A having the second groove formed thereon is formed on the second reflecting layer 32A.

The second recording layer 22A capable of optical recording is similar to the first recording layer 21A in material, thickness, and shape.

The translucent intermediate layer 4A has a role to bond the first substrates 11A having the first groove G1A formed thereon on which a first recording layer 21A and a first reflecting layer 31A are laminated in this order, with the second substrates 12A on which a second reflecting layer 32A, a transcription layer 5A having the second groove G2A formed thereon and a second recording layer 22A are laminated in this order, with the first reflecting layer 31A and the second recording layer 22A facing each other.

The material of the translucent intermediate layer 4A is not particularly limited and any material conventionally known to said bonding purpose can be used. For example, an ultraviolet curing resin is preferably used. The intermediate layer 4A normally has a thickness of about 40 μm, which is not particularly limited.

The layer structure of the optical recording medium 1 is not limited to that of FIG. 2. Other layers can be provided as appropriate as long as the foregoing layers are provided.

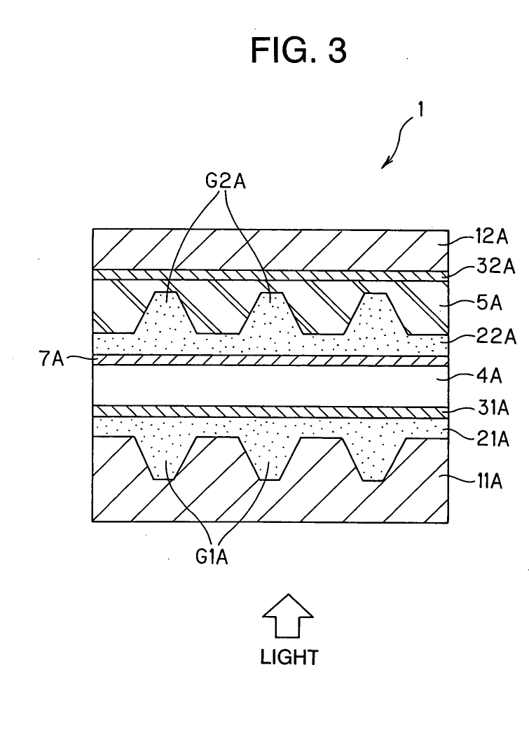

For example, as shown in FIG. 3, the optical recording medium 1 may comprise a protective layer 7A between the second recording layer 22A and the intermediate layer 4A. With the protective layer 7A, it is possible to prevent the second recording layer 22A from melting into an ultraviolet curing resin when the first reflecting layer 31A and the second recording layer 22A are bonded to each other via the intermediate layer 4A. The material and thickness of the protective layer 7A are not particularly limited and can be arbitrarily selected as long as the foregoing object is attained. In this case, translucency is necessary.

Further, in the optical recording medium 1 shown in FIG. 2, the first groove G1A of the first recording layer 21A and the second groove G2A of the second recording layer 22A are positioned in synchronization with each other (that is, overlaid on each other) in a direction orthogonal to the tracking direction. The arrangement of the first groove G1A of the first recording layer 21A and the second groove G2A of the second recording layer 22A is not limited to that of FIG. 2. The grooves may be positioned with a phase difference (that is, shifted from each other).

In the optical recording medium 1, a laser beam for recording or a laser beam for recording/reproduction is applied from the side of the first substrate 11A, and pits are formed on the first groove G1A of the first recording layer 21A, the lands of the first groove G1A, the second groove G2A of the second recording layer 22A, and the lands of the second groove G2A. Similarly a laser beam for reproduction or a laser beam for recording/reproduction is applied from the side of the first substrate 11A, and bit information formed on the first recording layer 21A and the second recording layer 22A is read.

The optical recording medium 1 can be a disc including a so-called DVD-R disc and a DVD-RW disc which are capable of recording and reproduction. Various kinds of recording mediums can be used according to a format, regardless of whether a record is erasable/rewritable or not and whether the recording medium is made of an organic dye other than the foregoing organic dyes.

As described above, according to the optical recording medium 1, the transcription layer 5A having the second groove formed thereon is provided between the second recording layer 22A and the second reflecting layer 32A and thus the first groove G1A and the second groove G2A in the optical recording medium 1 of the present invention can have the same thermal behavior, thereby achieving an equal signal amplitude in each the recording layer.

The following will describe a method of manufacturing the optical recording medium 1 according to the present embodiment.

The optical recording medium 1 is manufactured as follows: on the first-groove forming surface formed on one side of the first substrate 11A, an organic dye making up the recording medium is laminated to form the first recording layer 21A, which is formed according to the shape of the groove, the semi-translucent first reflecting layer 31A is laminated on the first recording layer 21A, the second reflecting layer 32A is laminated in the meantime on one side of the second substrate 12A, the transcription layer 5A having the second groove formed thereon is formed on the second reflecting layer 32A, an organic dye making up the recording medium is laminated on the second-groove forming surface of the transcription layer 5A to form the second recording layer 22A, which is formed according to the shape of the groove, and the first and second substrates are bonded to each other via the intermediate layer 4A with the first reflecting layer 31A and the second recording layer 22A facing each other.

The processes of the method will be described in detail below.

First, the first substrate 11A made of the above material with the above thickness is formed by injection molding of resin with a stamper. The first groove is formed on one side of the first substrate 11A.

Subsequently, the first recording layer 21A made of the above material with the above thickness is formed on the first-groove forming surface of the first substrate 11A. The method of forming the first recording layer 21A is not particularly limited. Spin coating or the like is used in ordinary cases. To be specific, when the first recording layer 21A is formed by spin coating, the material of the first recording layer 21A is dissolved and dispersed into a solvent to prepare coating slip, and the coating slip is spin coated onto the first substrate 11A.

When the complex of an azo compound is used as the material of the first recording layer 21A, tetrafluoropropanol or octafluoro-pentanol is used as the solvent of the coating slip. Further, when the cyanine dye is used as the material of the first recording layer 21A, ethyl cellosolve or dimethylcyclohexane is used as the solvent of the coating slip.

Then, the first reflecting layer 31A made of the above material with the above thickness is formed on the first recording layer 21A. The method of forming the first reflecting layer 31A is not particularly limited. Sputtering, deposition, and so on are used in ordinary cases.

The second reflecting layer 32A made of the above material with the above thickness is formed on one side of the second substrate 12A made of the above material with the above thickness. The method of forming the second reflecting layer 32A is similar to the foregoing method.

Subsequently, the transfer layer 5A which is made of the above material with the above thickness and has the second groove formed thereon is formed on the second reflecting layer 32A. The method of forming the transfer layer 5A is not particularly limited. For example, the transcription layer 5A can be formed by spin coating an ultraviolet curing resin used as a material, pressing thereto a stamper having a predetermined groove pattern, and applying ultraviolet rays to the resin via the stamper.

Then, the second recording layer 22A made of the above material with the above thickness is formed on the second-groove forming surface of the transcription layer 5A. The method of forming the second recording layer 22A is similar to that of the first recording layer 21A.

Finally, the first reflecting layer 31A and the second recording layer 22A are bonded to each other via the intermediate layer 4A. A conventionally known adhesive and so on can be used as the intermediate layer 4A.

In this way, the optical recording medium 1 of the present invention is manufactured.

When the protective layer is formed, the protective layer is formed on the second recording layer 22A by, e.g., spin coating and deposition.

According to the manufacturing method of the present embodiment, the optical recording medium 1 of the present invention can be readily formed with conventional processes and apparatus.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-345785 filed on Oct. 3, 2003 including the specification, claims, drawings and summary is incorporated herein by reference in its entirety.

1. An optical recording medium, in which a first substrate having a first groove formed thereon, a first recording layer formed on a first-groove forming surface of the first substrate, a semi-translucent first reflecting layer, an intermediate layer, a second recording layer, a second reflecting layer, and a second substrate are at least disposed in this order from a side where a laser beam for recording, reproduction, or recording/reproduction is applied,
the optical recording medium further comprising:
a translucent transcription layer, which has a second groove formed thereon, between the second recording layer and the second reflecting layer.

2. An optical recording medium according to claim 1, wherein the first substrate and the transcription layer are made of the same material.

3. A method of manufacturing an optical recording medium, comprising the steps of:
laminating a first recording layer made of a dye material and a semi-translucent first reflecting layer in this order on a first-groove forming surface of a first substrate,
laminating a second reflecting layer, a transcription layer having a second groove formed thereon, and a second recording layer made of a dye material in this order on one side of a second substrate, and
bonding the first and second substrates to each other via an intermediate layer with the first reflecting layer and the second recording layer facing each other.
